(19) United States
(12) Patent Application Publication
(10) Pub. No.: US 2026/0369630 A1
(43) Pub. Date: Nov. 19, 2026

(54) NOBLE-METAL-FREE HIGH-ENTROPY ALLOY POSITIVE ELECTRODE CATALYST FOR LITHIUM-OXYGEN BATTERY, PREPARATION METHOD AND USE THEREOF

(71) Applicants: SHANDONG UNIVERSITY, Jinan City (CN); SHANDONG ALLGRAND NEW ENERGY TECHNOLOGY CO., LTD., Dezhou City (CN)

(72) Inventors: Longwei YIN, Jinan City (CN); Lei LI, Jinan City (CN); Xianghui MENG, Dezhou City (CN)

(73) Assignees: SHANDONG UNIVERSITY, Jinan City (CN); SHANDONG ALLGRAND NEW ENERGY TECHNOLOGY CO., LTD., Dezhou City (CN)

(21) Appl. No.: 19/405,023

(22) Filed: Dec. 1, 2025

(30) Foreign Application Priority Data
Mar. 17, 2025 (CN) 202510311126.9

(51) Int. Cl. H01M 4/90; H01M 4/86; H01M 4/88; H01M 4/92; H01M 12/08

(52) U.S. Cl. CPC H01M 4/9058; H01M 4/8828; H01M 4/926; H01M 12/08; H01M 2004/8689

(57) ABSTRACT

Provided are a noble-metal-free high-entropy alloy positive electrode catalyst for a lithium-oxygen battery, a preparation method and use thereof. The preparation method includes: dissolving a surfactant, a copper salt, a cobalt salt, a nickel salt, a manganese salt, a molybdenum salt, a cerium salt, and a reducing agent in a solvent and conducting a reaction, and subjecting a resulting reaction product to a first centrifugation and then a first washing, and re-dispersing a resulting washed product in a dispersant to obtain an NHEA@CeOₓ nanoparticle dispersion; and mixing and dispersing the NHEA@CeOx nanoparticle dispersion and a conductive carbon black dispersion, and subjecting a resulting mixture to a second centrifugation, a second washing, and drying in sequence.

### CROSS REFERENCE TO RELATED APPLICATION

This patent application claims the benefit and priority of Chinese Patent Application No. 202510311126.9 filed with the China National Intellectual Property Administration on Mar. 17, 2025, the disclosure of which is incorporated by reference herein in its entirety as part of the present application.

### TECHNICAL FIELD

The present disclosure belongs to the field of material synthesis and electrochemical energy storage, and in particular relates to a noble-metal-free high-entropy alloy positive electrode catalyst for a lithium-oxygen battery, a preparation method and use thereof.

### BACKGROUND

Currently, more than 80% of global energy demand is supplied by fossil fuels, and the excessive use of fossil energy releases a large amount of CO₂ gas, leading to global warming and the “greenhouse effect”. The development of clean and renewable energy sources such as solar, wind, and tidal energy is key to addressing the energy crisis and environmental pollution caused by the depletion of traditional fossil energy sources, while the development of new energy storage systems is an effective means to overcome the intermittency dilemma of renewable energy and achieve efficient storage and distribution. The rapid development of new energy vehicles has created an equally urgent demand for power batteries with high safety, high performance, and low cost. Since 1991, lithium-ion batteries have been widely used in various fields, including portable electronic devices, smart power grids, and electric vehicles, due to long cycle life, no memory effect, and other advantages. To date, commercial lithium-ion batteries based on a graphite negative electrode have reached the upper energy density limit (350 Whkg⁻¹), yet still fail to satisfy the pressing demands of long-range electric vehicles for a high energy density. Therefore, the development of new power batteries to replace lithium-ion batteries is of critical strategic significance for transforming the energy storage landscape and breaking through the bottlenecks in the development of new energy vehicles.

Metal-oxygen batteries based on oxygen redox chemistry—including lithium-oxygen batteries (Li—O₂), sodium-oxygen batteries (Na—O₂), potassium-oxygen batteries (K—O₂), zinc-air batteries (Zn-air), and aluminum-oxygen batteries (Al—O₂)—have attracted significant research and development interests from both the scientific community and industry. Theoretically, compared with a lithium-ion battery using a metal oxide as the positive electrode, a metal-oxygen battery uses O₂ as an active material, thus having higher theoretical energy density, lower cost, and environmental friendliness. Among them, the lithium-oxygen battery is the most popular metal-oxygen battery. The lithium-oxygen battery is an energy storage technology that utilizes a metallic lithium negative electrode and oxygen as an active material of the positive electrode to release electrical energy through electrochemical reactions. Thus, among all types of batteries, the lithium-oxygen battery can exhibit the highest theoretical energy density (3500 Wh kg⁻¹) and can achieve an energy density expected to reach 600 Wh kg⁻¹, which is a crucial power supply system for electric vehicles capable of achieving a range of 500 km to 800 km, making it one of the most attractive candidates for next-generation electrochemical energy storage systems. Throughout the development, lithium-oxygen batteries have made significant progress in both technological research and industrialization, evolving from initial conceptual proposals to practical applications. As early as 1996, Abraham first reported a non-aqueous lithium-oxygen battery composed of a lithium metal as the negative electrode, an organic polymer as the electrolyte, and a porous carbon-oxygen positive electrode, and achieved reversible charge and discharge of the battery. In 2006, Bruce, et al., achieved the first reversible formation and decomposition of Li₂O₂, sparking widespread research interest in lithium-oxygen battery systems among researchers. In 2008, Toyota officially established the “battery research department”, accelerating the practical application of lithium-oxygen batteries. In 2009, IBM launched “Battery 500” project, which aims to develop high-specific-energy lithium-oxygen battery technology to meet the demand of electric vehicles for a 500 km range, thereby actively accelerating the practical development of lithium oxygen batteries. Later in 2017, Natural Resources Canada approved a 5 to 10 year research and development initiative titled “High Energy Density Storage Systems for Automotive Applications”, which proposed the development of 1,000 Wh kg⁻¹ lithium-oxygen batteries. Nowadays, research institutes, such as the Pacific Northwest National Laboratory, the United States Army Research Laboratory, and Argonne National Laboratory under the U.S. Department of Energy, are also intensifying research efforts in the direction of lithium-oxygen batteries.

Non-aqueous lithium-oxygen batteries have emerged as a strong candidate for next-generation energy storage systems due to high energy density, efficiency, cleanliness, safety, and excellent cycling performance. However, due to the intrinsic limitations of electrochemical reactions, lithium-oxygen batteries suffer from electrochemical properties that are difficult to meet the requirements of practical applications, in particular, severe charge-discharge polarization (low energy efficiency), low practical capacity, poor rate capability, and short cycle life. In particular, the lithium metal of the negative electrode is prone to dendrite formation and “dead lithium”, which leads to corrosion through reactions with oxygen diffusing from the positive electrode. The electrolyte is susceptible to degradation by attack from intermediate superoxide ions, as well as to volatilization in an open battery system; and the positive electrode suffers from a lack of efficient and stable bifunctional catalysts for both the oxygen reduction reaction (ORR) and oxygen evolution reaction (OER), resulting in high polarization potentials and limited cycle life. Currently, the main method of the negative electrode protection is similar to other lithium metal batteries, mostly by providing a coating on the lithium metal surface or forming an artificial SEI film. The common solution to the electrolyte problem is seeking a stable and non-volatile electrolyte system, as well as the application of solid-state electrolytes. The positive electrode catalyst and the mass transport structure are the most critical factors determining the electrochemical properties of the battery. The fundamental reason lies in the fact that the redox reactions in lithium-oxygen batteries primarily occur at the three-phase interface of the positive electrode; furthermore, the formed discharge product, i.e., lithium peroxide, is a wide-bandgap insulating material. Consequently, the positive electrode must simultaneously fulfill three critical functions: serving as a current collector, providing channels for the electrolyte (facilitating the diffusion of oxygen and lithium ions), and providing a space for the deposition of lithium peroxide, making the positive electrode the most critical component determining the performance of lithium-oxygen batteries. Therefore, developing a low-cost, high-performance positive electrode catalyst is of great significance for the practical application of lithium-oxygen batteries.

The current mainstream catalytic materials for the positive electrode are carbon materials, noble metals and compounds thereof, transition metals and compounds thereof, and other catalytic materials. Among them, carbon materials have high electrical conductivity and excellent catalytic performance. However, carbon materials face the persistent challenge of decomposition via attack by superoxide ions, leading to the formation of lithium carbonate byproducts, and are currently used as an auxiliary material to increase the conductivity. For example, Chinese patent CN106299552A discloses a lithium-air battery based on a graphitized carbon nanotube flexible film and a preparation method thereof, the battery having a graphitized carbon nanotube flexible film as an air positive electrode. The preparation method includes: first, preparing a carbon nanotube dispersion; then preparing a carbon nanotube film by using an aluminum foil or copper foil as a substrate; and finally, subjecting the carbon nanotube film to carbonization treatment, graphitization treatment, and calendering to obtain the graphitized carbon nanotube flexible film. However, the preparation method of the catalytic material for the positive electrode designed by this invention requires harsh conditions, such as high temperatures, and the catalyst is only made of a carbon material, resulting in limited battery performance. Noble metals and the oxides thereof exhibit excellent catalytic performance and have a fairly high stability. For example, Chinese patent CN118712401A discloses a carbon-supported PtFe sub-nanocluster as a positive electrode catalyst for lithium-oxygen batteries, which has good properties. However, the Pt used in the patent is a scarce and expensive noble metal, which is unsuitable for large-scale applications. Thus, considering the balance between catalytic functionality, stability, and cost, the noble-metal-free high-entropy alloys formed through the alloying of transition metals have a catalytic activity on par with a noble metal and superior stability, and are therefore considered a highly competitive catalyst system. In summary, how to rationally design the noble-metal-free high-entropy alloy catalyst and how to adjust and control the composition, morphology, and defects thereof to achieve optimal catalytic performance, ensure the reversible formation and decomposition of lithium peroxide, suppress the production of by-products, and improve battery performance are the focus of current research.

### SUMMARY

In view of the drawbacks of the current positive electrode catalysts for a lithium-oxygen battery in terms of activity, stability, and cost, the present disclosure provides a noble-metal-free high-entropy alloy positive electrode catalyst for a lithium-oxygen battery, a preparation method and use thereof. In the present disclosure, noble-metal-free six-element CuCoNiMnMoCe high-entropy alloy nanoparticles are synthesized by using a mild oil-phase co-reduction method. The addition of rare earth element Ce induces twinning of the alloy to form penta-twinned nanoparticles with a CeOₓ layer formed on the surface thereof, forming nanoparticles with a core-shell structure (NHEA@CeOₓ, CeOₓ-coated noble-metal-free high-entropy alloy), which are supported on the surface of carbon black to obtain a catalyst (NHEA@CeOₓ/C, carbon-supported NHEA@CeOₓ). In the present disclosure, the preparation method is simple and has low cost, being suitable for large-scale production. In the present disclosure, the catalyst can be used directly as a positive electrode catalyst for a lithium-oxygen battery, which has an extremely high catalytic activity and can optimize the morphology of the discharge product Li₂O₂, thereby significantly improving the capacity, cycling performance, and operating temperature range of the lithium-oxygen battery.

The present disclosure provides the following technical solutions:

The present disclosure provides a noble-metal-free high-entropy alloy positive electrode catalyst for a lithium-oxygen battery, the noble-metal-free high-entropy alloy positive electrode catalyst having a microscopic morphology in which penta-twinned, noble-metal-free CuCoNiMnMoCe six-element high-entropy alloy nanoparticles coated with an amorphous CeOₓ layer are supported on a surface of conductive carbon black, where x is greater than 1 and less than 2.

In the present disclosure, high-entropy is defined as entropy >(greater than) 1.5 R, where R is the ideal gas constant (8.314 J·mol⁻¹·K⁻¹).

In some embodiments, the penta-twinned, noble-metal-free CuCoNiMnMoCe six-element high-entropy alloy nanoparticles coated with the amorphous CeOₓ layer have a particle size of 10 nm to 20 nm, and the amorphous CeOₓ layer has a thickness of 1.5 nm to 2.5 nm.

The present disclosure provides a method for preparing the noble-metal-free high-entropy alloy positive electrode catalyst for the lithium-oxygen battery as described above, including the following steps:
(1) thoroughly dissolving a surfactant, a copper salt, a cobalt salt, a nickel salt, a manganese salt, a molybdenum salt, a cerium salt, and a reducing agent in a solvent and conducting a reaction, subjecting a resulting reaction product to centrifugation and then washing, and re-dispersing a resulting washed product into a dispersant to obtain an NHEA@CeOₓ nanoparticle dispersion; and
(2) thoroughly mixing and dispersing the NHEA@CeOₓ nanoparticle dispersion and a conductive carbon black dispersion, and subjecting a resulting mixture to centrifugation, washing, and drying in sequence to obtain the noble-metal-free high-entropy alloy positive electrode catalyst for the lithium-oxygen battery, i.e., an NHEA@CeOₓ/C powder.

In some embodiments, the surfactant in step (1) is cetyltrimethylammonium chloride.

In some embodiments, in step (1), the copper salt is selected from the group consisting of copper acetylacetonate and copper acetate; the cobalt salt is selected from the group consisting of cobalt acetylacetonate and cobalt acetate; the nickel salt is selected from the group consisting of nickel acetylacetonate and nickel acetate; the manganese salt is selected from the group consisting of manganese acetylacetonate and manganese acetate; the molybdenum salt is molybdenum hexacarbonyl; and the cerium salt is cerium acetylacetonate.

In some embodiments, the reducing agent in step (1) is selected from the group consisting of L-ascorbic acid, D-glucose anhydrous, and borane-morpholine complex; preferably, the reducing agent is a combination of the L-ascorbic acid, the D-glucose anhydrous, and the borane-morpholine complex, with a molar ratio of the L-ascorbic acid, the D-glucose anhydrous, and the borane-morpholine complex being 0.2-0.4:0.2-0.4:0.6-0.8, preferably 0.3:0.33:0.705.

In some embodiments, in step (1), the solvent is oleylamine; and a ratio of a total molar amount of the copper salt, the cobalt salt, the nickel salt, the manganese salt, the molybdenum salt, and the cerium salt to a volume of the solvent is in a range of 0.03 mol/L to 0.06 mol/L.

In some embodiments, in step (1), a molar ratio of the surfactant, the copper salt, the cobalt salt, the nickel salt, the manganese salt, the molybdenum salt, the cerium salt, and the reducing agent is in a range of 4.5-9:2-3:2-3:2-3:2-3:10-15:0.5-1.5:130-140, preferably 4.5-9:2.5: 2.5:2.5:2.5:12.5:0.5-1.5:133.5, further preferably 9:2.5:2.5:2.5:2.5:12.5:1:133.5.

In some embodiments, in step (1), the reaction is conducted at a temperature of 230 °C to 260 °C for 4 h to 6 h; and preferably, the reaction is conducted at a temperature of 245 °C for 5 h.

In some embodiments, a washing agent in the washing in step (1) is a mixture of cyclohexane and ethanol, with a volume ratio of the cyclohexane to the ethanol being 1:3 to 1:5, preferably 1:3.

In some embodiments, in step (1), the dispersant is cyclohexane; and a volume ratio of the dispersant to the solvent is in a range of 1:1 to 3:1.

In some embodiments, in step (2), the conductive carbon black dispersion is a dispersion of conductive carbon black in ethanol; and a concentration of the conductive carbon black in the conductive carbon black dispersion is in a range of 2 g/L to 3 g/L.

In some embodiments, in step (2), a mass ratio of the conductive carbon black in the conductive carbon black dispersion to the copper salt in step (1) is in a range of 2:1 to 5:1.

In some embodiments, in step (2), the thorough mixing and dispersion is conducted by ultrasonic mixing for 1 h to 2 h.

The present disclosure provides use of the noble-metal-free high-entropy alloy positive electrode catalyst for the lithium-oxygen battery as described above as a positive electrode material for the lithium-oxygen battery.

In some embodiments, a method for using the noble-metal-free high-entropy alloy positive electrode catalyst for the lithium-oxygen battery includes the following steps: thoroughly grinding and mixing a positive electrode catalyst for the lithium-oxygen battery and a binder, adding N-methylpyrrolidone or isopropanol thereto, and thoroughly dispersing a resulting mixture to obtain a slurry; and uniformly applying the slurry onto carbon paper, and drying to obtain a positive electrode for the lithium-oxygen battery. In some embodiments, a mass ratio of the positive electrode catalyst for the lithium-oxygen battery to the binder is in a range of 3:1 to 5:1; and the binder is selected from the group consisting of polytetrafluoroethylene and polyvinylidene fluoride.

In some embodiments, in the positive electrode for the lithium-oxygen battery, a loading of the catalyst for the lithium-oxygen battery is in a range of 0.2 mg cm⁻² to 0.3 mg cm⁻².

In some embodiments, the lithium-oxygen battery includes a positive electrode, a lithium sheet as a negative electrode, a separator, and an organic electrolyte; and the organic electrolyte is prepared by dissolving lithium bis(trifluoromethanesulfonyl)imide (LiTFSI) in tetraethylene glycol dimethyl ether (TEGDME), with a concentration of the lithium bis(trifluoromethanesulfonyl)imide (LiTFSI) being 0.5 mol L⁻¹ to 1 mol L⁻¹.

The technical features and beneficial effects of some embodiments in the present disclosure are as follows:
1. In the present disclosure, low-cost hydrogen-rich reducing agents are developed, and penta-twinned, noble-metal-free CuCoNiMnMoCe six-element high-entropy alloy nanoparticles coated with an amorphous CeOₓ layer are prepared by using a low-temperature oil-phase co-reduction method. A resulting alloy nanoparticles are then supported on a surface of conductive carbon black to obtain a high-performance low-cost noble-metal-free high-entropy alloy catalyst, which is supported on carbon paper and used as a positive electrode material for advanced lithium-oxygen batteries. In the present disclosure, the catalyst can be prepared by using a simple and scalable method with mild conditions and low cost, making it suitable for large-scale production. The synthesized catalyst exhibits exceptionally high catalytic activity and stability. When assembled into a lithium-oxygen battery, the lithium-oxygen battery has outstanding cycling stability, along with significantly enhanced performance in terms of capacity and operating temperature range.
2. In the present disclosure, a copper salt, a cobalt salt, a nickel salt, a manganese salt, a molybdenum salt, a cerium salt, a reducing agent, and a surfactant are used as raw materials to synthesize, under mild and controllable reaction conditions, penta-twinned, noble-metal-free CuCoNiMnMoCe six-element high-entropy alloy nanoparticles coated with an amorphous CeOₓ layer; and the penta-twinned, noble-metal-free CuCoNiMnMoCe six-element high-entropy alloy nanoparticles are then supported on conductive carbon black to produce an efficient catalyst. In the present disclosure, the catalyst has a large number of highly efficient reactive sites to accelerate the reaction kinetics. In the present disclosure, the addition of the Ce atom has the following effects: first, the introduction of Ce with a large atomic radius into the lattice of CuCoNiMnMo induces significant lattice strain, further leading to the transformation of the alloy nanoparticles from a single-crystal to a penta-twinned structure; secondly, the ultra-low-electronegativity Ce is very easy to bond to oxygen to form an amorphous CeOₓ layer on the surface of alloy nanoparticles, thus forming a unique structure of penta-twinned noble-metal-free high-entropy alloy coated with an amorphous oxide layer.
3. In the present disclosure, in the preparation of the NHEA@CeOₓ nanoparticles, the transition metal salt used is a specific kind of salt, with acetylacetonate or acetate ions as a special ligand of metal ions allowing the effective control of the reduction process, thus ensuring the formation of high-entropy alloy nanoparticles. In addition, the presence of surfactants is also essential, which ensures that the produced NHEA@CeOₓ has good dispersibility and uniform size. If there is no surfactant present, the NHEA@CeOₓ nanoparticles produced by the reaction vary in size and shape and have poor dispersibility, losing the advantages of nanoparticles. In the present disclosure, the specific types and ratios of raw materials facilitate the acquisition of the NHEA@CeOₓ nanoparticles.
4. In the present disclosure, the choice of a reducing agent is essential in the preparation of the NHEA@CeOₓ nanoparticles. In the present disclosure, borane-morpholine complex, D-glucose anhydrous, and L-ascorbic acid as a mixed reducing agent, and molybdenum hexacarbonyl as a molybdenum salt are preferred. The primary mechanism involves the thermal decomposition of the morpholine-borane complex and molybdenum hexacarbonyl to generate H₂ and CO, respectively, thereby creating a strong reducing atmosphere. This atmosphere, coupled with the powerful electron-acquiring capabilities of D-glucose anhydrous and L-ascorbic acid, collectively overcomes the high miscibility barriers between the non-noble metal elements.
5. In the present disclosure, the NHEA@CeOₓ/C is a catalyst consisting of an amorphous CeOₓ layer-coated penta-twinned, noble-metal-free high-entropy alloy nanoparticles with a core-shell structure supported on conductive carbon black. The penta-fold twinning of the alloy nanoparticles results in the five-fold exposure of the active (111) crystal planes, giving a dramatic increase in the number of reactive sites; and the contact of the surface CeOₓ layer with the internal alloy forms a semiconductor-metal heterojunction. The difference in the work functions of the two leads to the spontaneous transfer of electrons from CeOₓ to the surface Cu and Ni active sites on the alloy. The increased charge density at the active sites fills the d-orbitals, thereby weakening the binding energy with oxygen species. This accelerates the reaction kinetics while inhibiting the oxidation of the active sites, ultimately enhancing the cycling stability. On the other hand, the amorphous porous CeOₓ protective layer on the surface inhibits the leaching of alloy metal atoms and the “storage” of reactants (Li+and O₂), thereby ensuring structural stability and operation stability across a wide temperature range. In the present disclosure, the synergistic effects mentioned above enable the NHEA@CeOₓ/C material, when used in the positive electrode of a lithium-oxygen battery, to exhibit good electrochemical performance, effectively suppress side reactions, and greatly reduce the formation of by-products (lithium carbonate, lithium hydroxide, etc.), and optimize the morphology of the discharge product Li₂O₂, thereby improving the capacity and cycle life of the battery. A resulting battery can achieve a first discharge capacity of up to 17,987 mAh g⁻¹ at a current density of 100 mA g⁻¹, an overpotential of 0.39 V when the cutoff capacity is 1,000 mAh g⁻¹, and stable cycling over 405 cycles at a high current density. More importantly, the resulting battery can achieve stable cycling for 265 and 145 cycles at extreme temperatures of −20°C and 80 °C, respectively.

### BRIEF DESCRIPTION OF THE DRAWINGS

FIG. 1A shows a TEM (transmission electron microscope) image of the Pt nanoparticles prepared in step 1) of Comparative Example 1; FIG. 1B shows a TEM image of the alloy nanoparticles prepared in step 1); FIG. 1C shows a TEM image of the NHEA@CeOₓ prepared in Example 1; FIG. 1D shows an HAADF-STEM (high-angle annular dark-field-scanning transmission electron microscopy) image of the NHEA@CeOₓ prepared in Example 1;

FIG. 2A shows an HRTEM (high-resolution transmission electron microscopy) image of the alloy nanoparticles prepared in step 1) of Comparative Example 2; FIG. 2B shows an HRTEM image of the NHEA@CeOₓ prepared in Example 1; FIG. 2C shows a HAADF-STEM image (the scale is 5 nm) of the NHEA@CeOₓ prepared in Example 1, and FIG. 2D shows a HAADF-STEM image (the scale is 2 nm) of the locally magnified region in FIG. 2C;

FIG. 3 shows a mapping image of the NHEA@CeOₓ prepared in Example 1.

FIG. 4 shows XRD (X-ray diffraction) spectra of the alloy nanoparticles (NHEA) prepared in Comparative Example 2 and NHEA@CeOₓ prepared in Example 1;

FIG. 5A shows XANES (X-ray Absorption Near Edge Structure) spectra at the Cu K-edge of Cu foil, Cu₂O, CuO, NHEA, and NHEA@CeOx; FIG. 5B shows Fourier transforms of the EXAFS (Extended X-ray Absorption Fine Structure) spectra of the Cu K-edge in R space; FIG. 5C shows wavelet transforms for Cu K-edge EXAFS signals; FIG. 5D shows XANES spectra at the Ni K-edge of Ni foil, NiO, NHEA, and NHEA@CeOx; FIG. 5E shows Fourier transforms of the EXAFS spectra of the Ni K-edge in R space; FIG. 5F shows wavelet transforms for Ni K-edge EXAFS signals; FIG. 5G shows the fitted average valence states of Cu species in NHEA and NHEA@CeOx; FIG. 5H shows the fitted average valence states of Ni species in NHEA and NHEA@CeOx; and FIG. 5I shows the schematic illustration of the Schottky heterojunction in NHEA@CeOx, where W_{NHEA} and W_{CeOx} represent the work functions of the NHEA and CeOx, respectively, E_{F,N} and E_{F,C} represent Fermi-energy levels of the NHEA and CeOx, respectively, E_{CBM} is the bottom of the conduction band, E_{VBM} is the top of the valence band, E_{vac} is vacuum-energy level, E represents the built-in electric field, and Φ_{M} represents the Schottky barrier;

FIG. 6A shows the cyclic voltammetry (CV) curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ); FIG. 6B shows the charge/discharge curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ) at a current density of 200 mA g⁻¹ and a limited specific capacity of 1,000 mAh g⁻¹; FIG. 6C shows the first-cycle discharge curves (voltage versus specific capacity curves without capacity limitation) of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ) at a current density of 100 mA g⁻¹; FIG. 6D shows the rate performance test curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ); FIG. 6E shows the cycle life plots of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ) at 25 °C, a current density of 500 mA g⁻¹, and a limited specific capacity of 1,000 mAh g⁻¹; FIG. 6F shows a cycle life plot of the lithium-oxygen battery assembled from the positive electrode for a lithium-oxygen battery prepared in Example 1 (NHEA@CeOₓ) at 80 °C, a current density of 300 mA g⁻¹, and a limited specific capacity of 600 mAh g⁻¹; FIG. 6G shows a cycle life plot of the lithium-oxygen battery assembled from the positive electrode for a lithium-oxygen battery prepared in Example 1 (NHEA@CeOₓ) at −20 °C, a current density of 200 mA g⁻¹, and a limited specific capacity of 600 mAh g⁻¹;

FIG. 7A shows an SEM (scanning electron microscope) image of the discharge products of the lithium-oxygen batteries assembled from the positive electrodes for a lithium-oxygen battery prepared in Comparative Example 1 (Pt for short), FIG. 7B shows an SEM (scanning electron microscope) image of the discharge products of the lithium-oxygen batteries assembled from the positive electrodes for a lithium-oxygen battery prepared in Comparative Example 2 (NHEA for short), and FIG. 7C shows an SEM (scanning electron microscope) image of the discharge products of the lithium-oxygen batteries assembled from the positive electrodes for a lithium-oxygen battery prepared in Example 1 (NHEA@CeOₓ);

FIG. 8A shows XRD spectra of the discharge product of the lithium-oxygen battery assembled from the positive electrode for a lithium-oxygen battery prepared in Example 1 (NHEA@CeOₓ); FIG. 8B shows XRD spectra of the discharge products of lithium-oxygen batteries assembled from the positive electrodes for a lithium-oxygen battery prepared in Comparative Example 1 (Pt for short) and Comparative Example 2 (NHEA for short); and FIG. 8C shows XPS (X-ray photoelectron spectroscopy) Li 1s fine spectra of the lithium-oxygen battery assembled from the positive electrode for a lithium-oxygen battery prepared in Example 1 (NHEA@CeOₓ) in different states;

FIG. 9 shows an HAADF-STEM image of the alloy nanoparticles prepared in Example 4;

FIG. 10 shows an HAADF-STEM image of the alloy nanoparticles prepared in Example 5;

FIG. 11A shows the charge/discharge curves of the lithium-oxygen batteries assembled from the positive electrodes for a lithium-oxygen battery prepared in Example 1 (NHEA@CeOₓ for short), Example 4 (NHEA@CeOₓ-1.5 for short), and Example 5 (NHEA@CeOₓ-3.2 for short) at a current density of 200 mA g⁻¹ and a limited specific capacity of 1,000 mAh g⁻¹; and FIG. 11B shows the first-cycle discharge curves (voltage versus specific capacity curves without capacity limitation) of the lithium-oxygen batteries assembled from the positive electrodes for a lithium-oxygen battery prepared in Example 1 (NHEA@CeOₓ), Example 4 (NHEA@CeOₓ-1.5 for short), and Example 5 (NHEA@CeOₓ-3.2 for short) at a current density of 100 mA g⁻¹;

FIG. 12 shows HAADF-STEM images and EDS mapping images of the catalyst prepared in Comparative Example 3;

FIG. 13A shows the charge/discharge curves of the lithium-oxygen batteries assembled from the positive electrodes for a lithium-oxygen battery prepared in Example 1 (NHEA@CeOₓ for short) and Comparative Example 3 (S-NHEA for short) at a current density of 200 mA g⁻¹and a limited specific capacity of 1,000 mAh g⁻¹; and FIG. 13B shows the first-cycle discharge curves (voltage versus specific capacity curves without capacity limitation) of the lithium-oxygen batteries assembled from the positive electrodes for a lithium-oxygen battery prepared in Example 1 (NHEA@CeOₓ) and Comparative Example 3 (S-NHEA for short) at a current density of 100 mA g⁻¹.

### DETAILED DESCRIPTION OF THE EMBODIMENTS

The present disclosure is further described below through specific examples in conjunction with the accompanying drawings, but is not limited thereto.

The raw materials used in the examples are all conventional and commercially available; and unless otherwise specified, the described methods for preparing the raw materials are those in the prior art.

### Example 1

A method for preparing a noble-metal-free high-entropy alloy positive electrode catalyst for a lithium-oxygen battery was conducted as follows:
1) Preparation of NHEA@CeOₓ nanoparticles: 30 mg (0.09 mmol) of cetyltrimethylammonium chloride was dissolved in 5 ml of oleylamine and then sonicated for 15 minutes; then 6.5 mg (0.025 mmol) of copper acetylacetonate, 8.9 mg (0.025 mmol) of cobalt acetylacetonate, 6.4 mg (0.025 mmol) of nickel acetylacetonate, 8.8 mg (0.025 mmol) of manganese acetylacetonate, 5 mg (0.01 mmol) of cerium acetylacetonate, 33 mg (0.125 mmol) of molybdenum hexacarbonyl, 60 mg (0.30 mmol) of L-ascorbic acid, 60 mg (0.33 mmol) of D-glucose anhydrous, and 70 mg (0.705 mmol) of borane-morpholine complex were added thereto, sonicated for 1 h until dissolved, and reacted in an oil bath at 245 °C for 5 h; and then a resulting reaction solution was centrifuged, centrifugally washed 2 times with a 1:3 (by volume) cyclohexane/ethanol solution (11,000 rpm, 2 min) and then dispersed in 10 ml of cyclohexane to obtain an NHEA@CeOₓ nanoparticle dispersion.
2) Preparation of NHEA@CeOₓ/C: A solution of 25 mg of conductive carbon black (C) dispersed in 10 ml of ethanol was added to the NHEA@CeOₓ nanoparticle dispersion, sonicated for 2 h and mixed, and a resulting mixture was centrifuged, centrifugally washed with ethanol (8,000 rpm, 3 min), and dried under vacuum at 60 °C for 12 h to obtain an NHEA@CeOₓ/C powder.

Preparation of a positive electrode for the lithium-oxygen battery: 8 mg of the NHEA@CeOₓ/C powder and 2 mg of polyvinylidene fluoride (PVDF) were ground and mixed, and then added to 1.5 ml of N-methylpyrrolidone (NMP) to obtain a slurry; and the slurry was stirred for 12 h, then applied evenly to a carbon paper and dried to obtain the positive electrode for the lithium-oxygen battery. The loading of the active material (i.e., NHEA@CeOₓ/C) was calculated to be 0.2 mg cm⁻² to 0.3 mg cm⁻².

### Example 2

A method for preparing a noble-metal-free high-entropy alloy positive electrode catalyst for a lithium-oxygen battery was conducted according to the procedures in Example 1, except that in step 1), 15 mg (0.045 mmol) of cetyltrimethylammonium chloride was dissolved in 5 ml of oleylamine and then sonicated for 15 minutes; then 5 mg (0.025 mmol) of copper acetate, 4.8 mg (0.025 mmol) of manganese acetate, 5 mg (0.01 mmol) of cerium acetylacetonate, 4.4 mg (0.025 mmol) of cobalt acetate, 4.4 mg (0.025 mmol) of nickel acetate, 33 mg (0.125 mmol) of molybdenum hexacarbonyl, 60 mg (0.30 mmol) of L-ascorbic acid, 60 mg (0.33 mmol) of D-glucose anhydrous, and 70 mg (0.705 mmol) of borane-morpholine complex were added thereto, sonicated for 1 h until dissolved, and reacted in an oil bath at 245 °C for 5 h; and then a resulting reaction solution was centrifuged, centrifugally washed 2 times with a 1:3 (by volume) cyclohexane/ethanol solution (11,000 rpm, 2 min) and then dispersed in 10 ml of cyclohexane to obtain an NHEA@CeOₓ nanoparticle dispersion.

The other steps and conditions were the same as those in Example 1.

The preparation of a positive electrode for the lithium-oxygen battery was the same as in Example 1.

### Example 3

A method for preparing a noble-metal-free high-entropy alloy positive electrode catalyst for a lithium-oxygen battery was conducted according to the procedures in Example 1.

Preparation of a positive electrode for the lithium-oxygen battery: 8 mg of the NHEA@CeOₓ/C powder and 2 mg of polytetrafluoroethylene (PTFE) were ground and mixed, and then added to 2 ml of isopropanol to obtain a slurry; and the slurry was stirred for 12 h, then applied evenly to a carbon paper and dried to obtain the positive electrode for the lithium-oxygen battery. The loading of the active material (i.e., NHEA@CeOₓ/C) was calculated to be 0.2 mg cm⁻² to 0.3 mg cm⁻².

### Example 4

A method for preparing a noble-metal-free high-entropy alloy positive electrode catalyst for a lithium-oxygen battery was conducted according to the procedures in Example 1, except that in step 1), an amount of cerium acetylacetonate was 2.5 mg (0.005 mmol); and the other steps and conditions were the same as those in Example 1.

The preparation method of a positive electrode for the lithium-oxygen battery was the same as in Example 1.

### Example 5

A method for preparing a noble-metal-free high-entropy alloy positive electrode catalyst for a lithium-oxygen battery was conducted according to the procedures in Example 1, except that in step 1), an amount of cerium acetylacetonate was 7.5 mg (0.015 mmol); and the other steps and conditions were the same as those in Example 1.

The preparation method of a positive electrode for the lithium-oxygen battery was the same as in Example 1.

### Comparative Example 1

A method for preparing a Pt nanoparticle catalyst for a lithium-oxygen battery was conducted as follows:
1) Preparation of Pt nanoparticles: 15 mg of cetyltrimethylammonium chloride was dissolved in 5 ml of oleylamine and then sonicated for 15 minutes; then 9.8 mg of platinum acetylacetonate and 60 mg of D-glucose anhydrous were added thereto, sonicated for 1 h until dissolved, and reacted in an oil bath at 230 °C for 2 h; and then a resulting reaction solution was centrifuged, centrifugally washed 2 times with a 1:3 (by volume) cyclohexane/ethanol solution (11,000 rpm, 2 min) and then dispersed in 10 ml of cyclohexane to obtain a Pt nanoparticle dispersion.
2) Loading of Pt nanoparticles: A solution of 25 mg of conductive carbon black (C) dispersed in 10 ml of ethanol was added to the Pt nanoparticle dispersion, sonicated for 2 h and mixed, and a resulting mixture was centrifuged, centrifugally washed with ethanol (8,000 rpm, 3 min), and dried under vacuum at 60 °C for 12 h to obtain a Pt/C powder.

Preparation of a positive electrode for the lithium-oxygen battery: 8 mg of the Pt/C powder and 2 mg of polyvinylidene fluoride (PVDF) were ground and mixed, and then added to 1.5 ml of N-methylpyrrolidone (NMP) to obtain a slurry; and the slurry was stirred for 12 h, then applied evenly to a carbon paper and dried to obtain the positive electrode for the lithium-oxygen battery. The loading of the active material (i.e., Pt/C) was calculated to be 0.2 mg cm⁻² to 0.3 mg cm⁻².

### Comparative Example 2

A method for preparing a catalyst for a lithium-oxygen battery was conducted according to the procedures in Example 1, except that in step 1), no cerium acetylacetonate was added; and the other steps and conditions were the same as those in Example 1. An NHEA/C powder was obtained.

Preparation of a positive electrode for the lithium-oxygen battery: 8 mg of the NHEA/C powder and 2 mg of polyvinylidene fluoride (PVDF) were ground and mixed, and then added to 1.5 ml of N-methylpyrrolidone (NMP) to obtain a slurry; and the slurry was stirred for 12 h, then applied evenly to a carbon paper and dried to obtain the positive electrode for the lithium-oxygen battery. The loading of the active material (i.e., the NHEA/C powder) was calculated to be 0.2 mg cm⁻² to 0.3 mg cm⁻².

### Comparative Example 3

A method for preparing a catalyst for a lithium-oxygen battery was conducted according to the procedures in Comparative Example 2, except that in step 1), neither borane-morpholine complex as a reducing agent nor L-ascorbic acid was added; and the other steps and conditions were the same as those in Comparative Example 2. A S-NHEA/C powder was obtained.

Preparation of a positive electrode for the lithium-oxygen battery: 8 mg of the S-NHEA/C powder and 2 mg of polyvinylidene fluoride (PVDF) were ground and mixed, and then added to 1.5 ml of N-methylpyrrolidone (NMP) to obtain a slurry; and the slurry was stirred for 12 h, then applied evenly to a carbon paper and dried to obtain the positive electrode for the lithium-oxygen battery. The loading of the active material (i.e., the S-NHEA/C powder) was calculated to be 0.2 mg cm⁻² to 0.3 mg cm⁻².

### Test Example 1

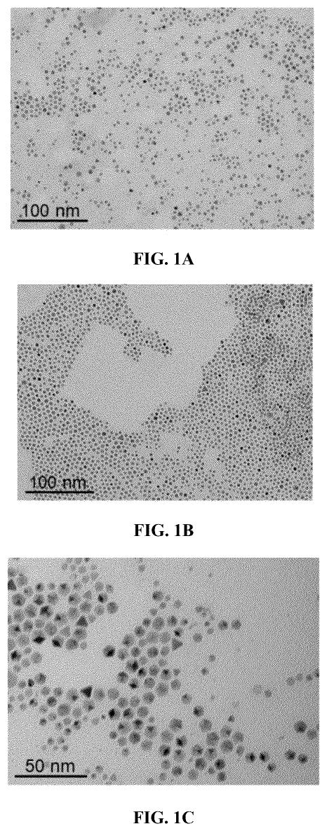

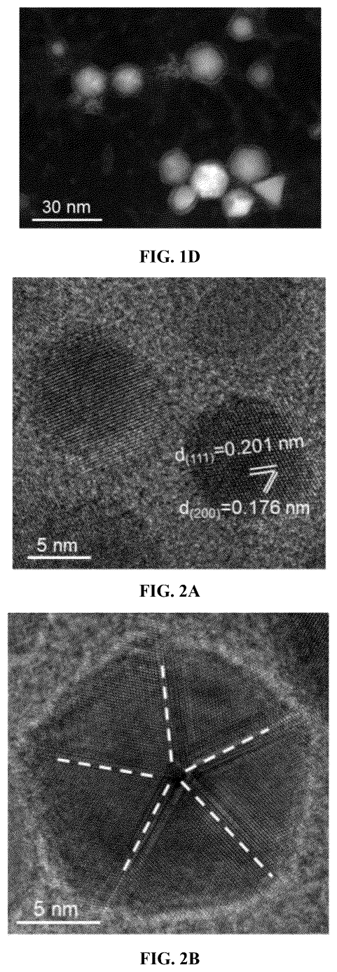

The TEM image of the Pt nanoparticles prepared in step 1) of Comparative Example 1 is shown in FIG. 1A; the TEM image of the alloy nanoparticles prepared in step 1) of Comparative Example 2 is shown in FIG. 1B; and the TEM and HAADF-STEM images of the NHEA@CeOₓ prepared in Example 1 are shown in FIGS. 1C and 1D. As can be seen from the figures, the NHEA@CeOₓ obtained in the present disclosure is penta-twinned, noble-metal-free CuCoNiMnMoCe six-element high-entropy alloy nanoparticles coated with a CeOₓ layer.

### Test Example 2

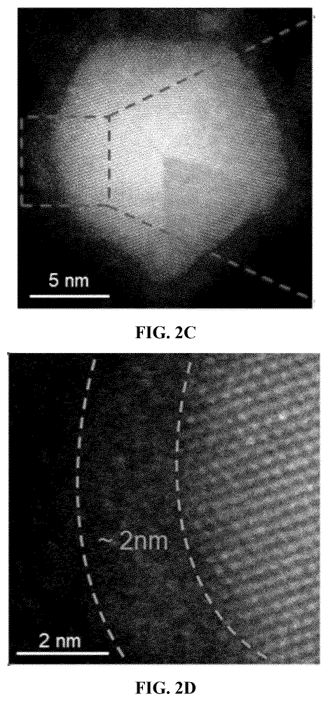

The HRTEM images of the alloy nanoparticles prepared in step 1) of Comparative Example 2 and the NHEA@CeOₓ prepared in Example 1 are shown in FIGS. 2A and 2B. The figures show that the alloy nanoparticles prepared in step 1 of Comparative Example 2 are single crystals with good crystallinity; the NHEA@CeOₓ of the present disclosure is in a penta-twinned state. This is because the incorporation of Ce into the crystal lattice generates severe strain, further inducing the evolution of single crystals into a penta-twinned structure.

The HAADF-STEM images of the NHEA@CeOₓ prepared in Example 1 are shown in FIGS. 2C and 2D, demonstrating that the surface of the penta-twinned nanoparticles is uniformly coated with an amorphous CeOₓ layer having a thickness of about 2 nm, which is formed due to the bonding of ultra-low-electronegativity Ce with oxygen.

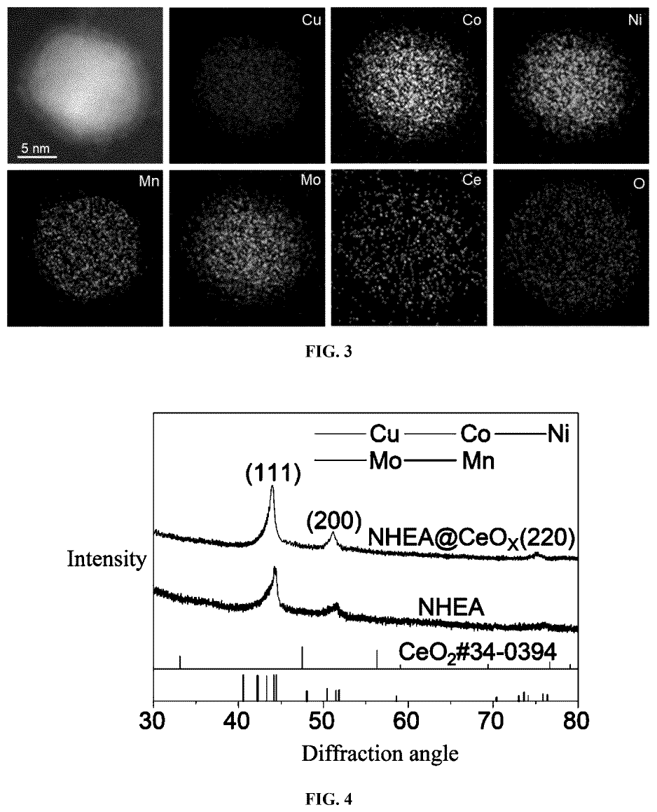

The mapping image of the NHEA@CeOₓ prepared in Example 1 is shown in FIG. 3, demonstrating that Cu, Co, Ni, Mn, Mo, and Ce are uniformly distributed within the crystalline interior of the nanoparticles, and the dispersed Fe and O signals on the surface serve as evidence that the amorphous layer is composed of CeOₓ.

The XRD spectra of the alloy nanoparticles (NHEA) prepared in step 1) of Comparative Example 2 and the XRD spectra of the NHEA@CeOₓ prepared in Example 1 are shown in FIG. 4. As can be seen from the figure, the alloy nanoparticles prepared in Comparative Example 2 have good crystallinity and have a face-centered cubic structure, primarily exposing three crystal planes, and the formation of the alloy structure is confirmed by the distinct diffraction peak positions corresponding to the five transition metals. Compared with the alloy nanoparticles prepared in Comparative Example 2, the NHEA@CeOₓ prepared in Example 1 exhibits a slight negative shift in diffraction peak positions, demonstrating that the incorporation of Ce into the crystal lattice causes the lattice spacing to become larger. No characteristic peak of CeOₓ is observed, confirming the amorphous character of the layer.

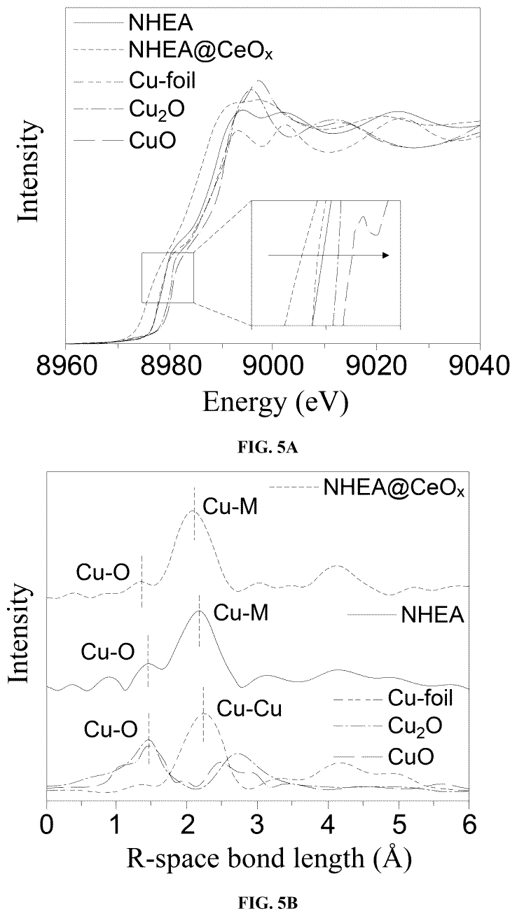

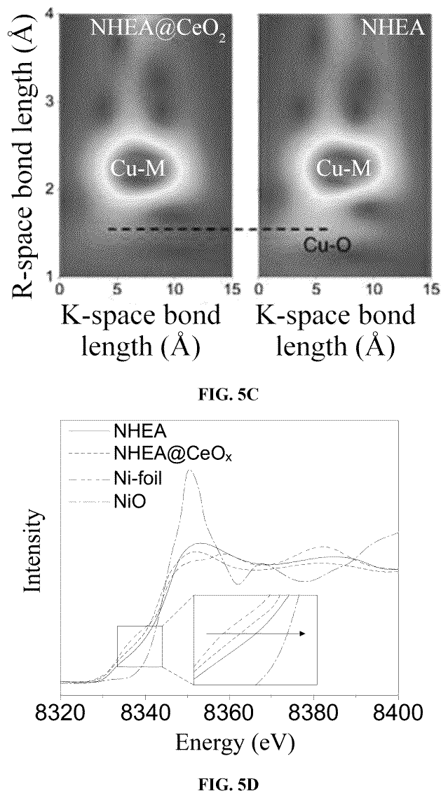

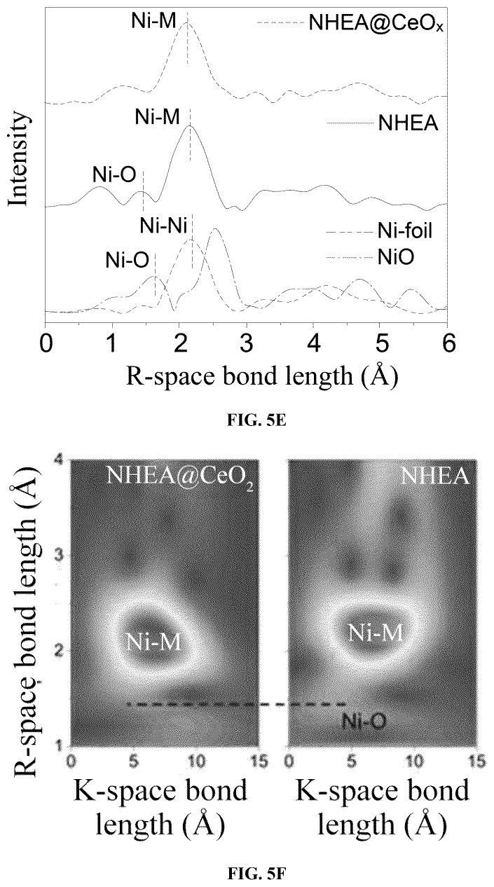

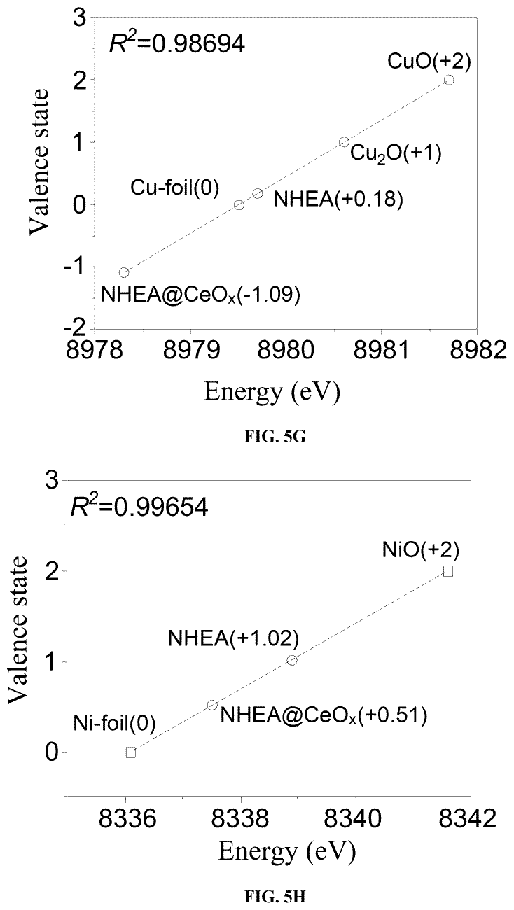

The XAFS (X-ray absorption fine structure) spectra of the NHEA/C (NHEA for short) prepared in Comparative Example 2 and the NHEA@CeOₓ/C (NHEA@CeOₓ for short) prepared in Example 1 are shown in FIGS. 5A to 5H. Analysis shows that the introduction of CeOₓ increases the number of electrons at the Cu and Ni sites and significantly decreases the number of Cu—O and Ni—O bonds. The results show that the introduction of CeOₓ significantly impairs the adsorption of oxygen species at the active sites, contributing to accelerated reaction kinetics and improved cycle stability.

### Test Example 3

The positive electrodes for a lithium-oxygen battery prepared in the examples and comparative examples were cut into the desired size of an electrode sheet for use in CR2032-type coin cells (disks with a diameter of 13 mm) by using a punching machine, and were assembled, together with a lithium metal sheet as a negative electrode, a glass fiber as a separator, and a 1 mol L⁻¹ solution of lithium bis(trifluoromethanesulfonyl)imide (LiTFSI) in tetraethylene glycol dimethyl ether (TEGDME) as an organic electrolyte, into CR2032 lithium-oxygen coin cells in a glove box with a moisture and oxygen level below 0.5 ppm; and resulting coin cells were subjected to electrochemical tests in a 1.0-bar oxygen test chamber.

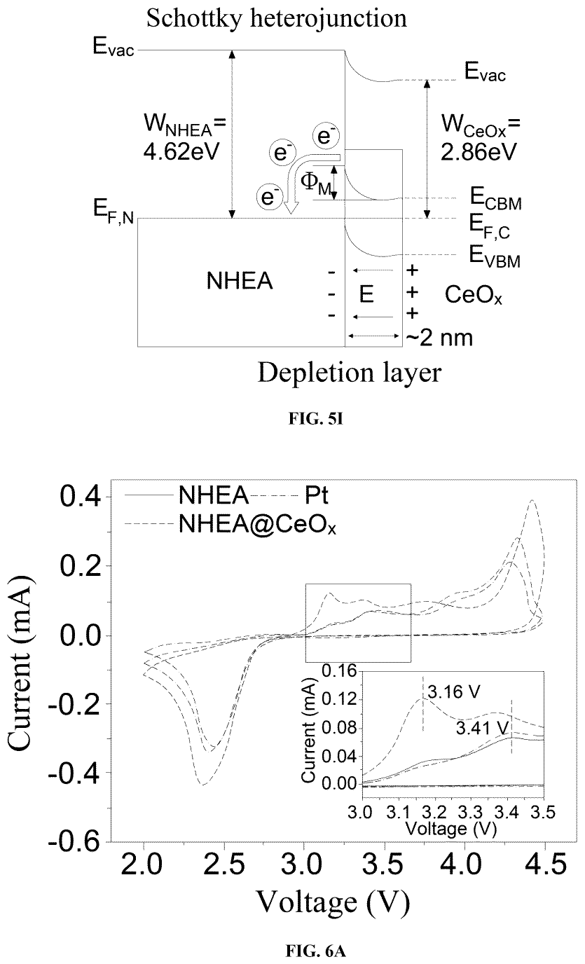

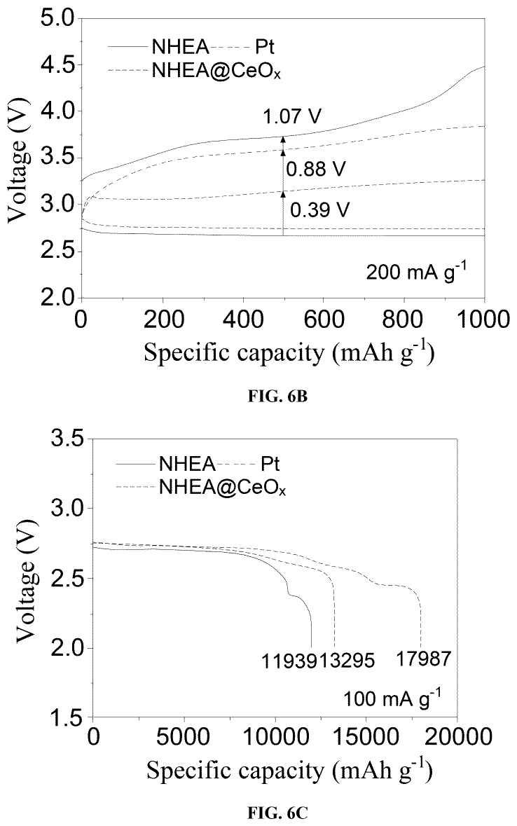

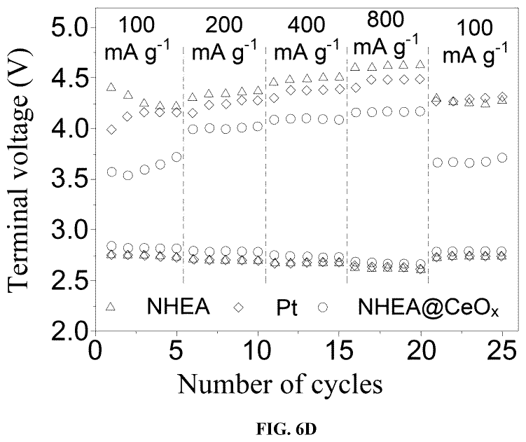

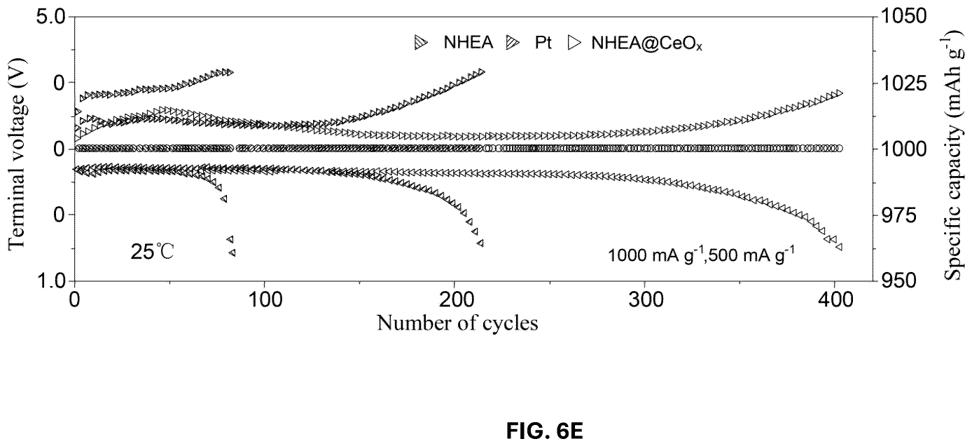

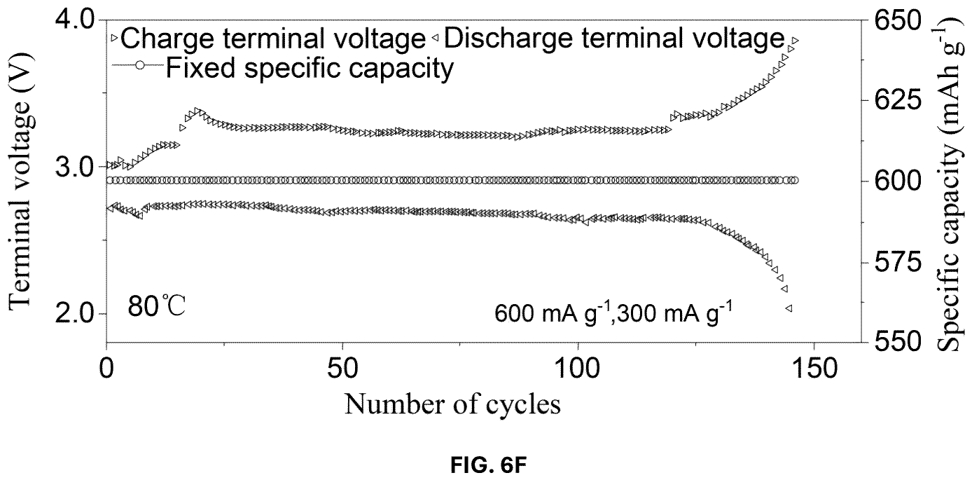

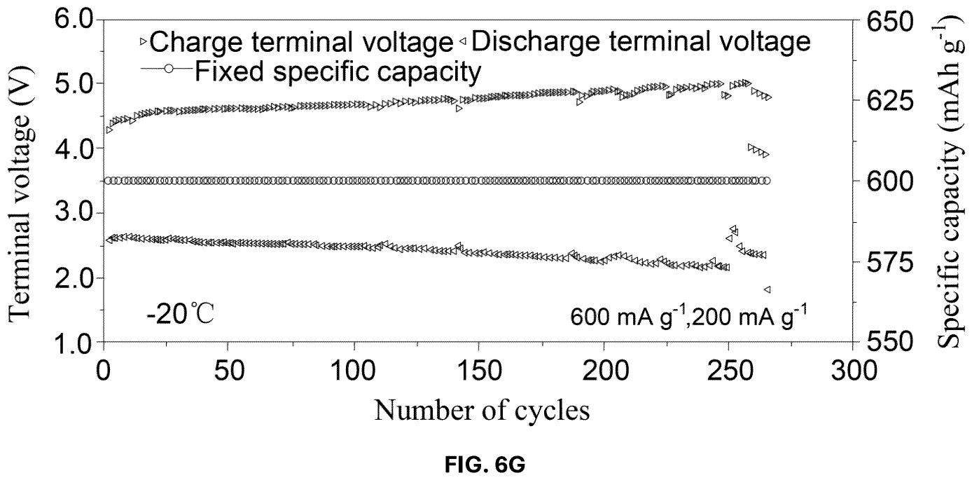

FIG. 6A shows the cyclic voltammetry (CV) curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ for short) at a scan rate of 0.1 mV s⁻¹ in a voltage range of 2.0 V to 4.5 V. As can be seen from the figure, the catalyst for a lithium-oxygen battery prepared in Example 1 of the present disclosure has a higher ORR onset potential and a lower OER onset potential, and the largest integral area indicates that the catalyst has a better bifunctional catalytic activity.

FIG. 6B shows the charge/discharge curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ for short) at a current density of 200 mA g⁻¹ and a limited specific capacity of 1,000 mAh g⁻¹. As can be seen from the figure, the catalyst for a lithium-oxygen battery prepared in Example 1 of the present disclosure has a higher discharge potential and a lower charge potential, with a charge-discharge overpotential of only 0.39 V, which is significantly lower than that of Pt (0.88 V) and Comparative Example 2 (1.07 V). While FIG. 6C shows the first-cycle charge/discharge curves at a current density of 100 mA g⁻¹ (voltage versus specific capacity curves without capacity limitation). As shown in the figure, the catalyst for a lithium-oxygen battery prepared in Example 1 has an ultra-high initial discharge specific capacity of 17,987 mAh g⁻¹, which is much higher than Comparative Example 1 (13,295 mAh g⁻¹) and Comparative Example 2 (11,939 mAh g⁻¹), indicating that the catalyst for a lithium-oxygen battery prepared in the present disclosure has an even better bifunctional catalytic activity.

FIG. 6D shows the rate performance test curves of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ for short). A comparison reveals that the catalyst for a lithium-oxygen battery prepared in Example 1 of the present disclosure exhibits the lowest charge-discharge overpotential at various current densities and the best rate performance.

FIG. 6E shows the cycle life plots of the lithium-oxygen batteries assembled from the positive electrodes for a lithium-oxygen battery prepared in Comparative Example 1 (Pt for short), Comparative Example 2 (NHEA for short), and Example 1 (NHEA@CeOₓ for short) at 25 °C, a current density of 500 mA g⁻¹, and a limited specific capacity of 1,000 mAh g⁻¹. As can be seen from the figure, the catalyst for a lithium-oxygen battery prepared in Example 1 of the present disclosure has good catalytic activity and could suppress the occurrence of side reactions, thus having a long cycle life (405 cycles).

FIG. 6F shows the cycle life plot of the lithium-oxygen battery assembled from the positive electrode for a lithium-oxygen battery prepared in Example 1 (NHEA@CeOₓ for short) at 80 °C, a current density of 300 mA g⁻¹, and a limited specific capacity of 600 mAh g⁻¹. FIG. 6G shows the cycle life plot of the lithium-oxygen battery assembled from the positive electrode for a lithium-oxygen battery prepared in Example 1 (NHEA@CeOₓ for short) at −20 °C, a current density of 200 mA g⁻¹, and a limited specific capacity of 600 mAh g⁻¹. As can be seen, the catalyst for a lithium-oxygen battery prepared in Example 1 of the present disclosure has operational stability across an ultra-wide temperature range, achieving 265 and 145 stable cycles at extreme temperatures of −20 °C and 80 °C, respectively, while retaining good catalytic activity.

### Test Example 4

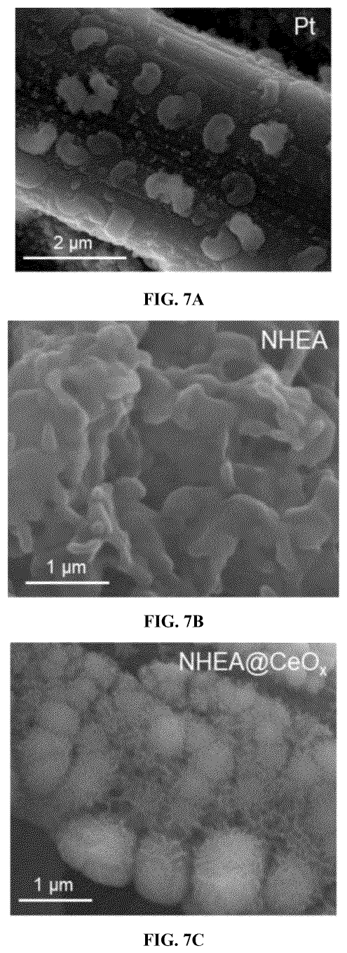

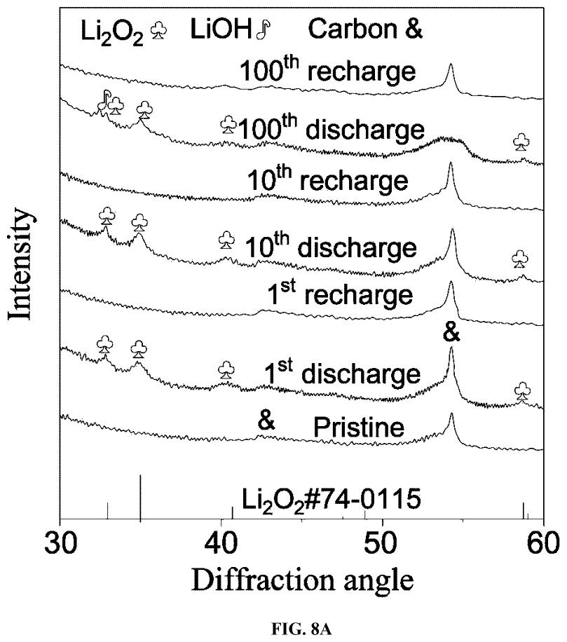

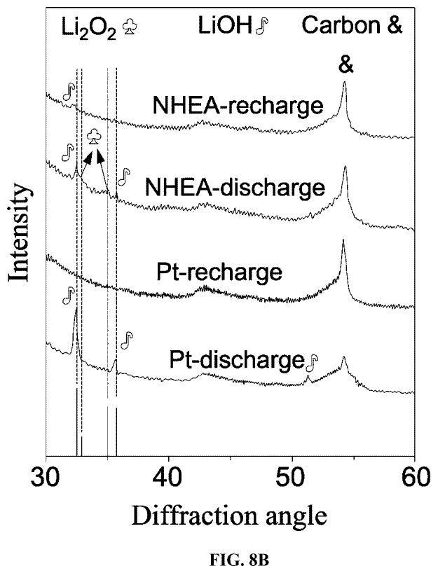

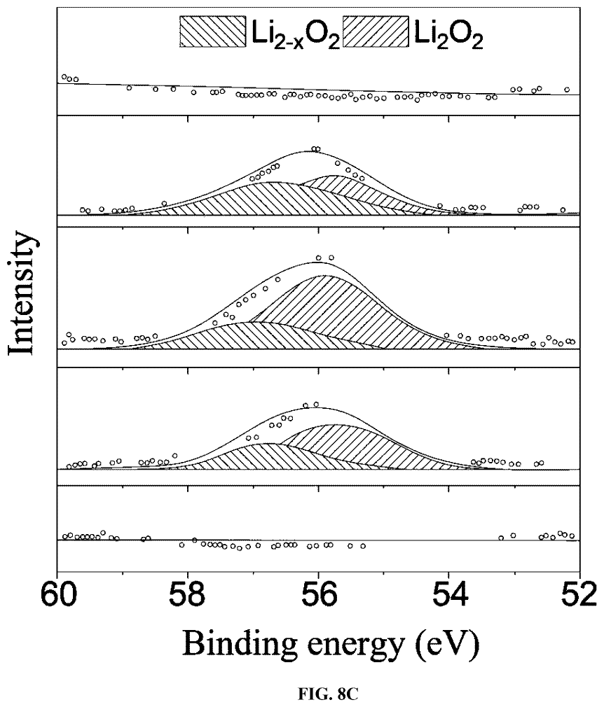

FIGS. 7 and 8 show the characterization of the discharge products during the charge and discharge processes of the batteries, illustrating the charge and discharge mechanism and the suppression of the side reaction process. The characterizations of the morphology of the discharge products of lithium-oxygen batteries assembled from the positive electrodes for a lithium-oxygen battery prepared in Comparative Example 1 (Pt for short), Comparative Example 2 (NHEA for short), and Example 1 (NHEA@CeOₓ for short) after 10 hours of discharge at a current density of 500 mAg⁻¹ are shown in FIGS. 7A, 7B, and 7C. The XRD spectra of the discharge products of the lithium-oxygen battery assembled from the positive electrode for a lithium-oxygen battery prepared in Example 1 (NHEA@CeOₓ for short) at different cycle numbers under a cut-off capacity of 1,000 mAh g⁻¹ and a current density of 500 mAg⁻¹ is shown in FIG. 8A. The XRD spectra of the discharge products of lithium-oxygen batteries assembled from the positive electrodes for a lithium-oxygen battery prepared in Comparative Example 1 (Pt for short) and Comparative Example 2 (NHEA for short) after 10 hours of discharge at a current density of 500 mAg⁻¹ are shown in FIG. 8B. The XPS Li 1s fine spectra of the lithium-oxygen battery assembled from the positive electrode for a lithium-oxygen battery prepared in Example 1 (NHEA@CeOₓ for short) at the initial state, after discharging for 5 hours at a current density of 500 mAg⁻¹, after discharging for 10 hours at a current density of 500 mAg⁻¹, after charging for 5 hours at a current density of 500 mAg⁻¹, and after charging for 10 hours at a current density of 500 mAg⁻¹ are shown in FIG. 8C, from top to bottom.

FIG. 7A shows an SEM image of the discharge product for the material prepared in Comparative Example 1 as the positive electrode. As can be seen, the discharge product on the Pt positive electrode exhibits a red blood cell-like morphology. Combined with FIG. 8B, the primary discharge product is red blood cell-like Li₂O₂. The lithium peroxide with such a morphology suggests a solution-mediated growth pathway where the nucleation and growth of the discharge product occurs in the solution. The large, red blood cell-like Li₂O₂ shares limited contact area with the catalyst, which is unfavorable for electron transfer and decomposition of the product. FIG. 7B shows an SEM image of the discharge product for the material prepared in Comparative Example 2 as the positive electrode. As can be seen, the discharge product exhibits a film-like morphology. Combined with FIG. 8B, the primary discharge product is film-like Li₂O₂. The lithium peroxide with such a morphology is formed via a surface-growth mechanism where the nucleation and growth of the discharge product occurs on the surface of the catalyst. The formation of the film-like Li₂O₂ covers the active sites, which is unfavorable for the suppression of side reactions. The discharge product for the material prepared in Example 1 of the present disclosure as a positive electrode is shown in FIG. 7C, which is lithium peroxide composed of needle-like subunits assembled into a nanoflower-like morphology. The lithium peroxide with such a morphology is formed via a synergistic surface-and solution-growth mechanism, without covering the active sites, thereby maintaining the high utilization efficiency of the positive electrode catalyst and avoiding side reactions. Thus, the battery exhibits excellent electrochemical properties, including high capacity, high rate capability, and long cycle life.

### Test Example 5

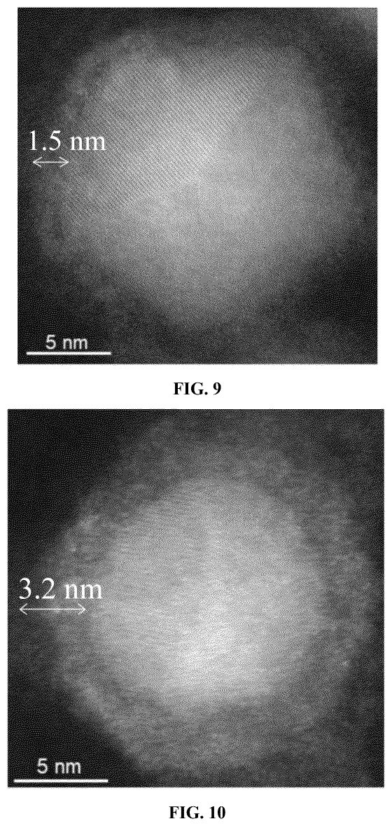

The HAADF-STEM images of the alloy nanoparticles prepared in step 1) of Example 4 and Example 5 are shown in FIG. 9 and FIG. 10, respectively.

As can be seen from FIG. 9, a low Ce doping amount results in a thinner CeOₓ layer with a thickness of about 1.5 nm.

As can be seen from FIG. 10, a higher Ce doping amount results in a thicker CeOₓ layer with a thickness of about 3.2 nm.

### Test Example 6

The positive electrodes for a lithium-oxygen battery prepared in Example 4 (NHEA@CeOₓ-1.5) and Example 5(NHEA@CeOₓ-3.2 ) were assembled into CR2032 lithium-oxygen coin cells by using the method as in Test Example 3, and resulting coin cells were subjected to electrochemical tests in a 1.0-bar oxygen test chamber.

FIG. 11A shows the charge/discharge curves of the lithium-oxygen batteries assembled from the positive electrodes for a lithium-oxygen battery prepared in Example 1 (NHEA@CeOₓ for short), Example 4(NHEA@CeOₓ-1.5 ), and Example 5(NHEA@CeOₓ-3.2 ) at a current density of 200 mA g⁻¹ and a limited specific capacity of 1,000 mAh g⁻¹. FIG. 11B shows the first-cycle charge/discharge curves (voltage versus specific capacity curves without capacity limitation) at a current density of 100 mA g⁻¹.

As can be seen from FIGS. 11A and 11B, both NHEA@CeOₓ-1.5 and NHEA@Ce_{Ox}-3.2 have a catalytic activity lower than that of NHEA@CeOₓ, including the overpotential at a current density of 200 mA g⁻¹ and the discharge capacity at a current density of 100 mA g⁻¹. The specific reasons are as follows: the over-thin CeOₓ layer cannot transfer enough electrons to the internal alloy nanoparticles to optimize the adsorption of key intermediates by the active sites; and an excessively thick CeOₓ layer hinders the adsorption of reactants onto the internal alloy nanoparticles for subsequent reactions, so the NHEA@CeOₓ with a moderate CeOₓ thickness has the optimal catalytic performance.

### Test Example 7

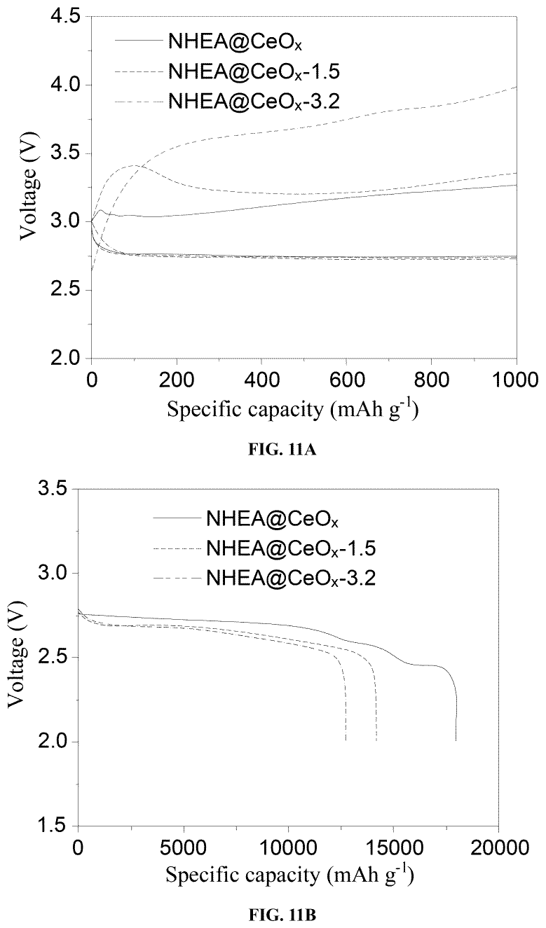

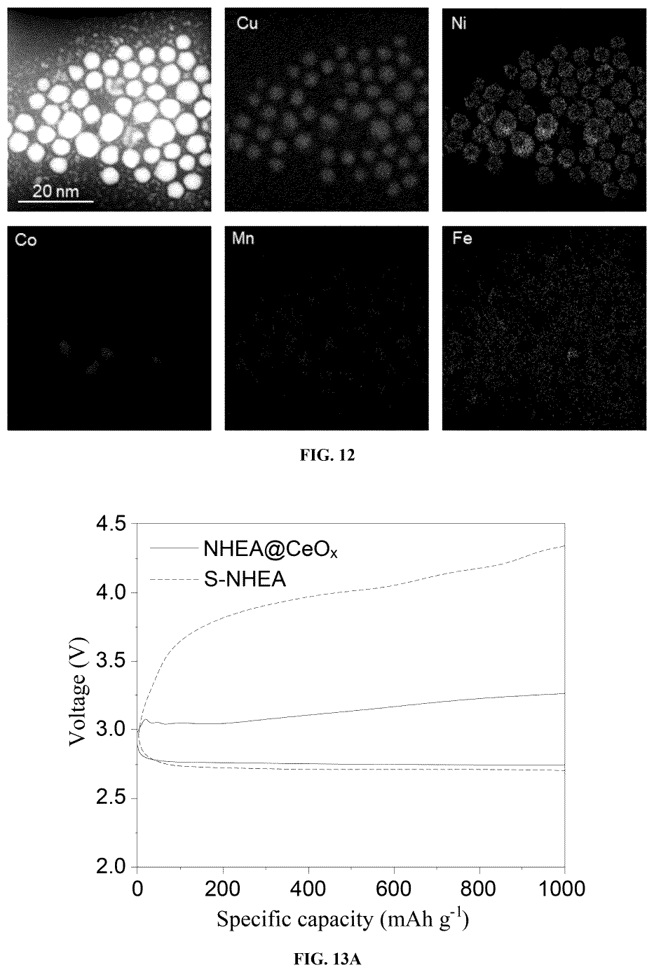

The HAADF-STEM image and mapping image of the alloy nanoparticles prepared in step 1) of Comparative Example 3 are shown in FIG. 12.

As can be seen from FIG. 12, the catalyst using only D-glucose anhydrous as a reducing agent exhibits a distinct phase separation morphology due to insufficient reducing capacity.

### Test Example 8

The positive electrode for a lithium-oxygen battery prepared in Comparative Example 3 (S-NHEA) was assembled into a CR2032 lithium-oxygen coin cell by using the method as in Test Example 3, and a resulting coin cell was subjected to electrochemical tests in a 1.0-bar oxygen test chamber.

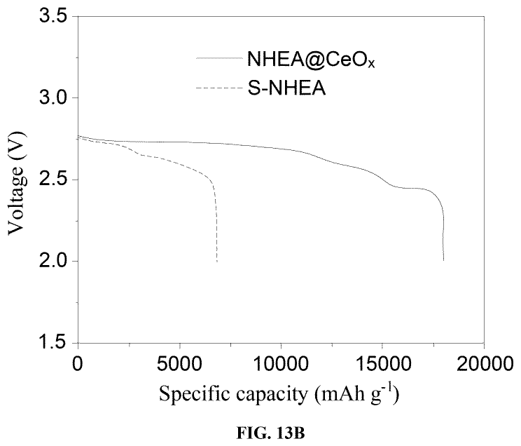

FIG. 13A shows the charge/discharge curves of the lithium-oxygen batteries assembled from the positive electrodes for a lithium-oxygen battery prepared in Example 1 (NHEA@CeOₓ for short) and Comparative Example 3 (S-NHEA) at a current density of 200 mA g⁻¹ and a limited specific capacity of 1,000 mAh g⁻¹. FIG. 13B shows the first-cycle charge/discharge curves (voltage versus specific capacity curves without capacity limitation) at a current density of 100 mAg⁻¹.

As can be seen from FIGS. 13A and 13B, owing to the distinct phase separation observed in the catalyst from Comparative Example 3, the catalytic performance (overpotential and discharge specific capacity) is inferior to that of the catalyst from Example 1.

What is claimed is:

1. A noble-metal-free high-entropy alloy positive electrode catalyst for a lithium-oxygen battery, the noble-metal-free high-entropy alloy positive electrode catalyst having a microscopic morphology in which penta-twinned, noble-metal-free CuCoNiMnMoCe six-element high-entropy alloy nanoparticles coated with an amorphous CeOₓ layer are supported on a surface of conductive carbon black, wherein x is greater than 1 and less than 2.

2. The noble-metal-free high-entropy alloy positive electrode catalyst for the lithium-oxygen battery of claim 1, wherein the penta-twinned, noble-metal-free CuCoNiMnMoCe six-element high-entropy alloy nanoparticles coated with the amorphous CeOₓ layer each have a particle size of 10 nm to 20 nm, and the amorphous CeOₓ layer has a thickness of 1.5 nm to 2.5 nm.

3. A method for preparing the noble-metal-free high-entropy alloy positive electrode catalyst for the lithium-oxygen battery of claim 1, comprising the following steps:
(1) dissolving a surfactant, a copper salt, a cobalt salt, a nickel salt, a manganese salt, a molybdenum salt, a cerium salt, and a reducing agent in a solvent and conducting a reaction, subjecting a resulting reaction product to a first centrifugation and then a first washing, and re-dispersing a resulting washed product in a dispersant to obtain an NHEA (noble-metal-free high-entropy alloy) @CeOₓ nanoparticle dispersion; and
(2) mixing and dispersing the NHEA@CeOₓ nanoparticle dispersion and a conductive carbon black dispersion, and subjecting a resulting mixture to a second centrifugation, a second washing, and drying in sequence to obtain the noble-metal-free high-entropy alloy positive electrode catalyst for the lithium-oxygen battery, i.e., an NHEA@CeOₓ/C powder.

4. The method of claim 3, wherein in step (1), one or more of the following conditions are comprised:
i, the surfactant is cetyltrimethylammonium chloride;
ii, the copper salt is selected from the group consisting of copper acetylacetonate and copper acetate; the cobalt salt is selected from the group consisting of cobalt acetylacetonate and cobalt acetate; the nickel salt is selected from the group consisting of nickel acetylacetonate and nickel acetate; the manganese salt is selected from the group consisting of manganese acetylacetonate and manganese acetate; the molybdenum salt is molybdenum hexacarbonyl; and the cerium salt is cerium acetylacetonate; and
iii, the solvent is oleylamine; and a ratio of a total molar amount of the copper salt, the cobalt salt, the nickel salt, the manganese salt, the molybdenum salt, and the cerium salt to a volume of the solvent is in a range of 0.03 mol/L to 0.06 mol/L.

5. The method of claim 3, wherein in step (1), the reducing agent is selected from the group consisting of L-ascorbic acid, D-glucose anhydrous, and borane-morpholine complex.

6. The method of claim 3, wherein in step (1), a molar ratio of the surfactant, the copper salt, the cobalt salt, the nickel salt, the manganese salt, the molybdenum salt, the cerium salt, and the reducing agent is in a range of 4.5-9:2-3:2-3:2-3:2-3:10-15:0.5-1.5:130-140.

7. The method of claim 3, wherein in step (1), one or more of the following conditions are comprised:
i, the reaction is conducted at a temperature of 230 °C to 260 °C for 4 hours to 6 hours; and
ii, the dispersant is cyclohexane; and a volume ratio of the dispersant to the solvent is in a range of 1:1 to 3:1.

8. The method of claim 3, wherein in step (2), one or more of the following conditions are comprised:
i, the conductive carbon black dispersion is a dispersion of conductive carbon black in ethanol;
and a concentration of the conductive carbon black in the conductive carbon black dispersion is in a range of 2 g/L to 3 g/L;
ii, a mass ratio of the conductive carbon black in the conductive carbon black dispersion to the copper salt in step (1) is in a range of 2:1 to 5:1; and
iii, the mixing and dispersion is conducted by ultrasonic mixing for 1 hour to 2 hours.

9. A lithium-oxygen battery, comprising the noble-metal-free high-entropy alloy positive electrode catalyst for the lithium-oxygen battery of claim 1 as a positive electrode active material for the lithium-oxygen battery.

10. A process for preparing a positive electrode for a lithium-oxygen battery, comprising:
grinding and mixing the noble-metal-free high-entropy alloy positive electrode catalyst for the lithium-oxygen battery of claim 1 and a binder, adding N-methylpyrrolidone or isopropanol thereto, and dispersing a resulting mixture to obtain a slurry; and
applying the slurry onto carbon paper, and drying to obtain the positive electrode for the lithium-oxygen battery.

11. The method of claim 5, wherein in step (1), the reducing agent is a combination of the L-ascorbic acid, the D-glucose anhydrous, and the borane-morpholine complex, with a molar ratio of the L-ascorbic acid, the D-glucose anhydrous, and the borane-morpholine complex being 0.2-0.4:0.2-0.4:0.6-0.8.

12. The method of claim 11, wherein the molar ratio of the L-ascorbic acid, the D-glucose anhydrous, and the borane-morpholine complex is 0.3:0.33:0.705.

13. The method of claim 6, wherein in step (1), the molar ratio of the surfactant, the copper salt, the cobalt salt, the nickel salt, the manganese salt, the molybdenum salt, the cerium salt, and the reducing agent is in a range of 4.5-9:2.5:2.5:2.5:2.5:12.5:0.5-1.5:133.5.

14. The method of claim 13, wherein in step (1), the molar ratio of the surfactant, the copper salt, the cobalt salt, the nickel salt, the manganese salt, the molybdenum salt, the cerium salt, and the reducing agent is 9:2.5:2.5:2.5:2.5:12.5:1:133.5.

15. The method of claim 7, wherein in step (1), the reaction is conducted at 245 °C for 5 hours.

16. The process of claim 10, wherein a ratio of the noble-metal-free high-entropy alloy positive electrode catalyst for the lithium-oxygen battery to the binder is in a range of 3:1 to 5:1; and the binder is selected from the group consisting of polytetrafluoroethylene and polyvinylidene fluoride.
